(19) United States
(12) Patent Application Publication
(10) Pub. No.: US 2018/0048902 A1
(43) Pub. Date: Feb. 15, 2018

(54) IMAGE PROCESSING SYSTEM, TRANSCODING METHOD, AND PROGRAM

(71) Applicant: DWANGO Co., Ltd., Chuo-ku, Tokyo (JP)

(72) Inventors: Takashi KOJIMA, Tokyo (JP); Takahiro YACHI, Tokyo (JP)

(21) Appl. No.: 15/557,676

(22) PCT Filed: May 24, 2016
(86) PCT No.: PCT/JP2016/065293

§ 371 Date: Sep. 12, 2017

(30) Foreign Application Priority Data
May 29, 2015 (JP) 2015-110495

(51) Int. Cl. H04N 19/40; H04N 19/426; H04N 19/152; H04N 19/184; H04N 19/139; H04N 19/103

(52) U.S. Cl. CPC H04N 19/40; H04N 19/139; H04N 19/103; H04N 19/152; H04N 19/184; H04N 19/426

(57) ABSTRACT

An image processing system according to the present invention has a decode unit for decoding a bit stream generated from moving-image data stored in a video signal storage unit and then stored in a temporary storage unit before the bit stream is deleted, a deletion unit for deleting the bit stream from the temporary storage unit, a decode information storage unit for storing decode information obtained by performing the decoding, and a transcode unit for transcoding the moving-image data stored in the video signal storage unit using the decode information.

### TECHNICAL FIELD

The present invention relates to an image processing system, a transcoding method, and a program.

Priority is claimed on Japanese Patent Application No. 2015-110495, filed May 29, 2015, the content of which is incorporated herein by reference.

### BACKGROUND ART

Systems for distributing moving images on the basis of a moving image distribution request are known (for example, see Patent Document 1). In some of the systems, moving image data (for example, posted moving image data) is held, and when a moving image distribution request is made, data (a bitstream) obtained by converting the held moving image data into a video rate or an image size suitable for a line band, a service, or the like of the requester is transmitted to the requester. In such systems, in general, the bitstream is cached (temporarily stored) for the purpose of reducing the amount of processing (such as CPU load or processing time) when a moving image distribution request is made, and if a cache hit occurs, i.e., if the corresponding bitstream is cached, the cached bitstream is read and transmitted without converting the moving image data into the bitstream.

### DOCUMENT OF THE PRIOR ART

### Patent Document

### Patent Document 1

Japanese Unexamined Patent Application, First Publication No. 2010-178147

### SUMMARY OF INVENTION

### Problems to be Solved by the Invention

However, since the cached bitstream is deleted for the purpose of preventing an increase in cache data, if a moving image distribution request is made after the deletion, it is necessary to generate a bitstream again (to convert the moving image data into a bitstream), and thus the amount of processing is not reduced.

The present invention has been made in view of the above circumstances and it is an object of the present invention to provide a technology which can reduce the amount of processing when a moving image distribution request is made while achieving a reduction in cache data.

### Means for Solving the Problems

In order to solve the above problem, an image processing system according to one aspect of the present invention includes a decoding unit configured to decode a bitstream, which is generated from moving image data stored in a video signal storage unit and is then stored in a temporary storage unit, before the bitstream is deleted, a deletion unit configured to delete the bitstream from the temporary storage unit, a decoding information storage unit configured to store decoding information obtained by performing the decoding, and a transcoding unit configured to transcode the moving image data stored in the video signal storage unit using the decoding information.

In the above image processing system, the decoding information may include at least one of vector information or mode information.

In the above image processing system, the decoding unit may be configured to perform decoding in response to input of an instruction to delete the bitstream from the temporary storage unit.

In the above image processing system, the transcoding unit may be configured to perform transcoding using the decoding information when the same or a different generation condition for generating the bitstream from the moving image data is given.

A transcoding method according to another aspect of the present invention includes decoding, by a decoding unit, a bitstream, which is generated from moving image data stored in a video signal storage unit and is then stored in a temporary storage unit, before the bitstream is deleted, deleting, by a deletion unit, the bitstream from the temporary storage unit, storing, by a decoding information storage unit, decoding information obtained by performing the decoding, and transcoding, by a transcoding unit, the moving image data stored in the video signal storage unit using the decoding information.

A program according to another aspect of the present invention causes a computer to function as a decoding means configured to decode a bitstream, which is generated from moving image data stored in a video signal storage unit and is then stored in a temporary storage unit, before the bitstream is deleted, a deletion means configured to delete the bitstream from the temporary storage unit, a decoding information storage means configured to store decoding information obtained by performing the decoding, and a transcoding means configured to transcode the moving image data stored in the video signal storage unit using the decoding information.

### Advantageous Effects of Invention

According to the present invention, before a bitstream which is cache data is deleted, the bitstream is decoded and decoding information is stored, and the decoding information is used when the bitstream is transcoded. Thus, bitstreams which are cache data are deleted and, in addition, when a moving image distribution request for a bitstream is made after the bitstream is deleted, it is possible to easily transcode moving image data using decoding information even though the bitstream which is case data is not present. That is, it is possible to reduce the amount of processing when a moving image distribution request is made while achieving a reduction in cache data.

### BRIEF DESCRIPTION OF DRAWINGS

FIG. 1 is a block diagram showing a configuration of an image processing system according to an embodiment of the present invention.

FIG. 2 is a configuration diagram showing a bitstream transmitted by a moving image distribution device shown in FIG. 1.

FIG. 3 is a block diagram showing the moving image distribution device shown in FIG. 1.

FIG. 4 is a flowchart showing processes when the moving image distribution device shown in FIG. 1 has received a moving image distribution request from a terminal device.

FIG. 5 is a flowchart showing a process when the moving image distribution device shown in FIG. 1 deletes a bitstream.

### EMBODIMENTS FOR CARRYING OUT THE INVENTION

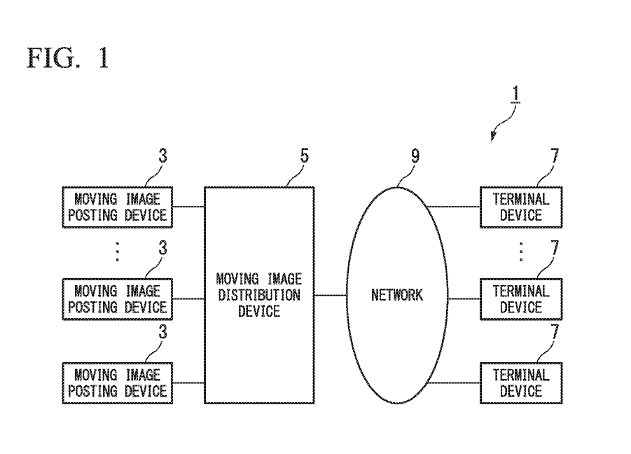

Hereinafter, an embodiment of the present invention will be described with reference to the drawings. FIG. 1 is a block diagram showing a configuration of an image processing system 1 according to an embodiment of the present invention.

As shown in FIG. 1, the image processing system 1 includes a moving image posting device 3, a moving image distribution device 5, and terminal devices 7. The moving image distribution device 5 and a plurality of terminal devices 7 are connected via a network 9 such as the Internet. All or a part of the moving image distribution device 5 and the plurality of moving image posting devices 3 may be connected via the network 9.

The moving image posting device 3 is realized by a personal computer, a tablet terminal, a smartphone, another device having a communication function (for example, a game machine, etc.), or the like. The moving image posting device 3 transmits (posts) moving image data to the moving image distribution device 5.

The moving image distribution device 5 is realized by one or more server computers or the like. The moving image distribution device 5 receives the moving image data transmitted from the moving image posting device 3. The moving image distribution device 5 stores the moving image data received from the moving image posting device 3. The moving image distribution device 5 also receives a moving image distribution request from a terminal device 7. Upon receiving a moving image distribution request from a terminal device 7, the moving image distribution device 5 transmits (distributes) a bitstream (described later) of a requested moving image to the requesting terminal device 7.

The moving image distribution request may include information (also referred to as requester identification information) identifying the requesting terminal device 7, information identifying the requested moving image (also referred to as moving image identification information), or the like.

The terminal device 7 is realized by a personal computer, a tablet terminal, a smartphone, another device having a communication function (for example, a game machine, etc.), or the like. The terminal device 7 transmits a moving image distribution request to the moving image distribution device 5 and receives and reproduces a bitstream (described later) transmitted from the moving image distribution device 5.

The moving image posting device 3 and the terminal device 7 may be the same device. That is, a certain device may be both the moving image posting device 3 and the terminal device 7.

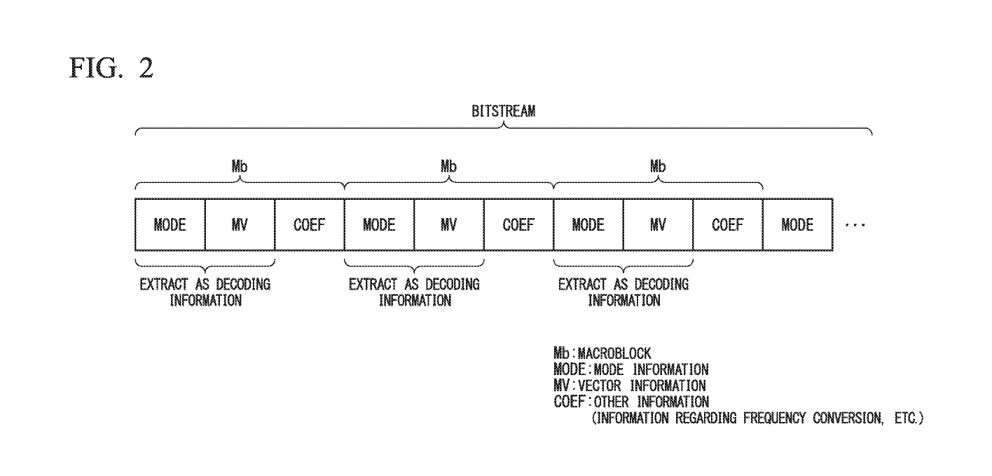

FIG. 2 shows an exemplary configuration of a bitstream transmitted by the moving image distribution device 5. Only portions related to the present embodiment are shown in FIG. 2.

A bitstream transmitted by the moving image distribution device 5 has, for example, a plurality of macroblocks as shown in FIG. 2 for each picture. Each macroblock includes mode information (information regarding an encoding mode) and vector information (information regarding a motion compensation vector, also referred to as vector information). When a bitstream is generated from moving image data, generating mode information (calculating an encoding mode) and generating vector information (calculating motion compensation vectors) takes up much of the time (70% to 90% of the total) and generating other information does not take up much time. The other information is information regarding frequency conversion, quantization, entropy conversion, and the like.

Mode information and vector information included in each macroblock is extracted as decoding information. Bitstreams (macroblocks) generated from the same moving image data are the same if standards (for example, file formats) of the bitstreams are the same. Therefore, decoding information extracted from a bitstream generated from certain moving image data can be used when a bitstream is generated from the moving image data. Using decoding information of certain moving image data when generating a bitstream of the moving image data eliminates the need to perform processes requiring much time (a process of generating mode information and a process of generating vector information). Therefore, when decoding information of certain moving image data is used to generate a bitstream of the moving image data, it is possible to greatly reduce the processing time compared to when the decoding information of the moving image data is not used. It does not take much time to perform a process of extracting the decoding information.

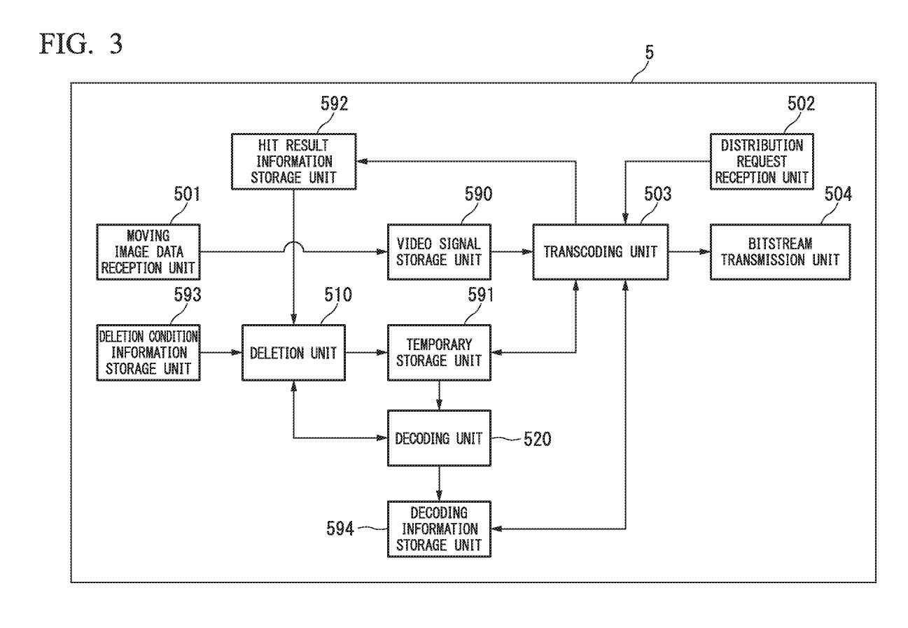

FIG. 3 is a functional block diagram showing an internal configuration of the moving image distribution device 5. Only functional blocks related to the present embodiment are shown in FIG. 3.

As shown in FIG. 3, the moving image distribution device 5 includes a moving image data reception unit 501, a distribution request reception unit 502, a transcoding unit 503, a bitstream transmission unit 504, a deletion unit 510, a decoding unit 520, a video signal storage unit 590, a temporary storage unit 591, a hit result information storage unit 592, a deletion condition information storage unit 593, and a decoding information storage unit 594.

The video signal storage unit 590 is a storage area for storing moving image data transmitted from the moving image posting device 3. The temporary storage unit 591 is a storage area for storing bitstreams. The hit result information storage unit 592 is a storage area for storing hit result information indicating a hit result indicating that a bitstream hits (is present) in the temporary storage unit 591. The deletion condition information storage unit 593 is a storage area for storing deletion condition information indicating a condition for deleting a bitstream stored in the temporary storage unit 591. An example of the deletion condition information is information indicating a condition that a bitstream be deleted when there is no hit result indicating that the bitstream hits equal to or greater than a predetermined number of times (for example, once) within a predetermined period (for example, 240 hours).

The decoding information storage unit 594 is a storage area for storing decoding information.

The moving image data reception unit 501 receives moving image data transmitted from the moving image posting device 3. The moving image data reception unit 501 stores the moving image data received from the moving image posting device 3 in the video signal storage unit 590. In order to identify each stored individual piece of moving image data, for example, the moving image data is stored in association with moving image identification information.

The distribution request reception unit 502 receives a moving image distribution request transmitted from the terminal device 7. Upon receiving the moving image distribution request from the terminal device 7, the distribution request reception unit 502 notifies the transcoding unit 503 of the moving image distribution request.

When a moving image distribution request has been made, the transcoding unit 503 provides requester information identifying the requesting terminal device 7 and a bitstream of a requested moving image to the bitstream transmission unit 504. Specifically, when the bitstream of the requested moving image is not stored in the temporary storage unit 591 and the decoding information (mode information and vector information) of the requested moving image is not stored in the decoding information storage unit 594, the transcoding unit 503 generates a bitstream from moving image data stored in the video signal storage unit 590 (by transcoding the moving image data) and provides the bitstream to the bitstream transmission unit 504.

When the bitstream of the requested moving image is stored in the temporary storage unit 591, the transcoding unit 503 reads the bitstream from the temporary storage unit 591 and provides the read bitstream to the bitstream transmission unit 504. On the other hand, when the bitstream of the requested moving image is not stored in the temporary storage unit 591 and the decoding information (mode information and vector information) of the requested moving image is stored in the decoding information storage unit 594, the transcoding unit 503 generates a bitstream from both the decoding information and moving image data stored in the video signal storage unit 590 and provides the bitstream to the bitstream transmission unit 504.

For example, the bitstream is provided together with the requester identification information to the bitstream transmission unit 504 in order to allow identification of which terminal device 7 the bitstream is to be transmitted to.

In the case in which the transcoding unit 503 generates a bitstream from moving image data stored in the video signal storage unit 590 and provides the bitstream to the bitstream transmission unit 504 when the bitstream of the requested moving image is not stored in the temporary storage unit 591 and the decoding information of the requested moving image is not stored in the decoding information storage unit 594, the bitstream is stored in the temporary storage unit 591.

In addition, for example, the bitstream is stored in association with moving image identification information in order to allow identification of a moving image of the bitstream.

In the case in which, when the bitstream of the requested moving image is stored in the temporary storage unit 591, the transcoding unit 503 reads the bitstream from the temporary storage unit 591 and provides the read bitstream to the bitstream transmission unit 504, the transcoding unit 503 stores, in the hit result information storage unit 592, hit result information indicating a hit result indicating that the bitstream hits in the temporary storage unit 591.

For example, the hit result information is stored in association with the moving image identification information in order to allow identification of the moving image of the hit bitstream.

The bitstream transmission unit 504 transmits the bitstream provided from the transcoding unit 503 to the requesting terminal device 7.

The deletion unit 510 determines whether or not to delete a bitstream stored in the temporary storage unit 591 on the basis of hit result information stored in the hit result information storage unit 592 and deletion condition information stored in the deletion condition information storage unit 593. Upon determining that a certain bitstream is to be deleted, the deletion unit 510 notifies the decoding unit 520 of a decoding information extraction request for requesting that decoding information of the bitstream be extracted.

In order to allow identification of a bitstream of the decoding information to be extracted, for example, the decoding information extraction request may include moving image identification information identifying the bitstream.

The deletion unit 510 deletes the bitstream from the temporary storage unit 591 after generating the decoding information.

When a decoding information extraction request has been made by the deletion unit 510, the decoding unit 520 extracts decoding information from the bitstream (specifically, a bitstream identified by the decoding information extraction request) stored in the temporary storage unit 591 (by decoding the bitstream) and stores the extracted decoding information in the decoding information storage unit 594.

In order to allow identification of a moving image of the decoding information (i.e., a moving image of a bitstream from which the decoding information has been extracted), for example, the decoding information is stored in association with moving image identification information.

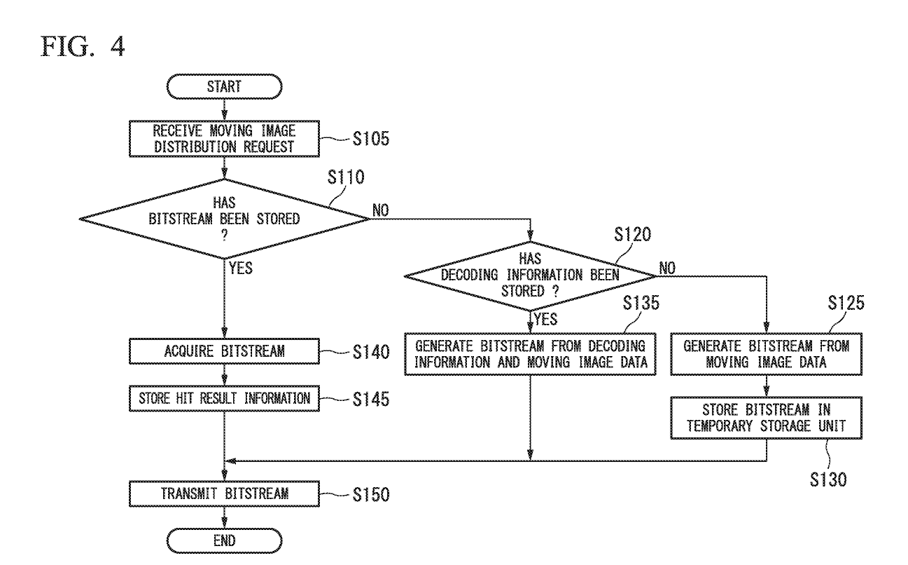

FIG. 4 is a flowchart showing processes when the moving image distribution device 5 has received a moving image distribution request from a terminal device 7.

As shown in FIG. 4, the distribution request reception unit 502 receives a moving image distribution request transmitted from a terminal device 7 (step S105). The distribution request reception unit 502 notifies the transcoding unit 503 of the moving image distribution request.

The transcoding unit 503 determines whether or not a bitstream of the requested moving image is stored in the temporary storage unit 591 (step S110). Upon determining in step S110 that the bitstream is not temporarily stored (step S110: NO), the transcoding unit 503 determines whether or not decoding information (mode information and vector information) of the requested moving image is stored in the decoding information storage unit 594 (step S120).

Upon determining in step S120 that the decoding information is not stored in the decoding information storage unit 594 (step S120: NO), the transcoding unit 503 generates a bitstream from the moving image data stored in the video signal storage unit 590 (step S125). In the process of step S135, a process of generating mode information (calculating an encoding mode) or a process of generating vector information (calculating a motion compensation vector) is performed when the bitstream is generated, unlike a process of step S135 described later.

Subsequent to the process in step S125, the transcoding unit 503 provides the bitstream generated in step S125 to the bitstream transmission unit 504 and also stores the bitstream in the temporary storage unit 591 (step S130). Subsequently, the bitstream transmission unit 504 transmits the bitstream provided from the transcoding unit 503 to the requesting terminal device 7 (step S150). Then, this flowchart ends.

Upon determining in step S120 that the decoding information is stored in the decoding information storage unit 594 (step S120: YES), the transcoding unit 503 generates a bitstream from both the decoding information and the moving image data stored in the video signal storage unit 590 (step S135). In the process of step S135, the bitstream is generated using the decoding information stored in the decoding information storage unit 594 without performing the process of generating mode information (calculating an encoding mode) or the process of generating vector information (calculating a motion compensation vector), and therefore it takes less time than the process of step S125.

Subsequent to step S135, the transcoding unit 503 provides the bitstream generated in step S135 to the bitstream transmission unit 504 and the bitstream transmission unit 504 transmits the bitstream provided from the transcoding unit 503 to the requesting terminal device 7 (step S150). Then, this flowchart ends.

Upon determining in step S110 that the bitstream is temporarily stored (step S110: YES), the transcoding unit 503 reads and acquires the bitstream from the temporary storage unit 591 (step S140). Subsequently, the transcoding unit 503 provides the bitstream acquired in step S140 to the bitstream transmission unit 504 and also stores hit result information indicating that the bitstream hits in the hit result information storage unit 592 (step S145). Subsequently, the bitstream transmission unit 504 transmits the bitstream provided from the transcoding unit 503 to the requesting terminal device 7 (step S150). Then, this flowchart ends.

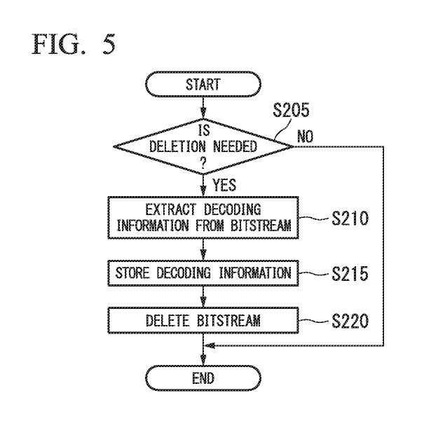

FIG. 5 is a flowchart showing processes when the moving image distribution device 5 deletes a bitstream. The flowchart of FIG. 5 may be performed as appropriate (for example, at a fixed time every day).

As shown in FIG. 5, the deletion unit 510 determines whether it is necessary to delete the bitstream stored in the temporary storage unit 591 on the basis of both the hit result information stored in the hit result information storage unit 592 and the deletion condition information stored in the deletion condition information storage unit 593 (step S205). This flowchart ends when it is determined in step S205 that it is not necessary to delete the bitstream (step S205: NO).

Upon determining in step S205 that it is necessary to delete the bitstream (step S205: YES), the deletion unit 510 notifies the decoding unit 520 of a decoding information extraction request for requesting that the decoding information be extracted and the decoding unit 520 extracts decoding information from the bitstream stored in the temporary storage unit 591 (step S210) and stores the extracted decoding information in the decoding information storage unit 594 (S215). Subsequently, the deletion unit 510 deletes the bitstream from the temporary storage unit 591 (step S220). Then, this flowchart ends.

The decoding unit 520 notifies the deletion unit 510 that the decoding information has been stored in the decoding information storage unit 594 and the deletion unit 510 deletes the bitstream from the temporary storage unit 591 after the notification. Thus, it is possible to delete the bitstream after extracting the decoding information from the bitstream.

According to the flowchart shown in FIG. 5, when it is determined that the bitstream is to be deleted (step S205: YES), the bitstream is deleted after the decoding information is extracted and stored (after the processes of step S210 and step S215 are performed) (step S220). Further, according to the flowchart shown in FIG. 4, even if the bitstream has not been cached (step S110: NO) when a moving image distribution request is made, the bitstream is generated using the decoding information (step S135) if the decoding information has been stored (step S120: YES).

That is, according to the flowcharts shown in FIGS. 4 and 5, even if the bitstream has already been erased when a moving image distribution request is made, in other words, even if a moving image distribution request is made after the bitstream is erased, it is possible to generate the bitstream using the decoding information. Therefore, it is possible to significantly reduce the processing time compared to the case in which the bitstream is generated without using decoding information (for example, compared to the case in which the process of step S125 in FIG. 4 is performed).

As described above, the image processing system 1 according to the embodiment of the present invention includes the deletion unit 510 which deletes a bitstream, which is stored in the temporary storage unit 591 after being generated (transcoded) from moving image data stored in the video signal storage unit 590, from the temporary storage unit 591, the decoding unit 520 which decodes the bitstream before the bitstream is deleted from the temporary storage unit 591, the decoding information storage unit 594 which stores decoding information acquired by performing decoding, and the transcoding unit 503 which generates (transcodes) moving image data stored in the video signal storage unit 590 using the decoding information. Thus, it is possible to reduce the amount of processing when a moving image distribution request is made while reducing bitstreams in the temporary storage unit 591.

In the above embodiment, the decoding unit 520 extracts both the vector information and the mode information as the decoding information. However, any one of the vector information and the mode information may be extracted as the decoding information.

Further, in the above embodiment, the decoding unit 520 extracts the decoding information in response to a decoding information extraction request made by the deletion unit 510. Here, this request is made in response to deletion of the bitstream from the temporary storage unit 591. That is, this request is made in response to input of an instruction to the temporary storage unit 591 to delete the bitstream from the temporary storage unit 591.

In the example shown in the above embodiment, the decoding unit 520 extracts the decoding information from the bitstream. However, the decoding unit 520 may extract decoding information for each generation condition (for example, an image size, etc.,) for generating the bitstream. That is, when mode information items and vector information items corresponding respectively to a plurality of generation conditions are included in a bitstream generated with a single generation condition, the decoding unit 520 may extract only decoding information corresponding to the single generation condition or may extract decoding information items corresponding respectively to the plurality of generating conditions. For example, the decoding unit 520 may extract only mode information and vector information corresponding to a generation condition A, which is a condition for generating a bitstream of image size a, as decoding information corresponding to the generation condition A from a bitstream generated with the generation condition A. Alternatively, the decoding unit 520 may extract mode information and vector information corresponding to generation condition A as decoding information corresponding to the generation condition A, extract mode information and vector information corresponding to generation condition B as decoding information corresponding to the generation condition B, and extract mode information and vector information corresponding to generation condition C as decoding information corresponding to the generation condition C. In the case in which the decoding unit 520 extracts decoding information items corresponding respectively to a plurality of generation conditions, the decoding unit 520 allows the decoding information storage unit 594 to store each of the extracted decoding information items. In order to allow identification of each of the extracted decoding information items, for example, each of the decoding information items is stored in association with information identifying the generation condition.

Therefore, when a bitstream corresponding to the generation condition A has been transmitted in response to a moving image distribution request, the bitstream corresponding to the generation condition A may be stored in the temporary storage unit 591, and thereafter, when a deletion condition is satisfied, the bitstream corresponding to the generation condition A may be deleted from the temporary storage unit 591, while decoding information corresponding to the generation condition A, decoding information corresponding to the generation condition B, and decoding information corresponding to the generation condition C may be stored in the decoding information storage unit 594. In this case, the transcoding unit 503 may perform transcoding using decoding information when the same or a different generation condition is given. That is, when a moving image distribution request is made again, a bitstream may be generated using decoding information corresponding to the generation condition A only when a generation condition of the bitstream to be transmitted according to the moving image distribution request that is made again is the generation condition A which is the same as a generation condition of the bitstream transmitted according to the previous moving image distribution request. A bitstream may also be generated using decoding information corresponding to the generation condition B or the generation condition C even when the generation condition of the bitstream to be transmitted according to the moving image distribution request that is made again is the generation condition B or the generation condition C which is different from the generation condition A of the bitstream transmitted according to the previous moving image distribution request.

In the above-described embodiment, when a bitstream is generated using decoding information, the generated bitstream is not stored in the temporary storage unit 591. However, even when a bitstream is generated using decoding information, the generated bitstream may be stored in the temporary storage unit 591, similar to when a bitstream is generated only from moving image data. That is, the same process as that of step S130 may be performed between the process of step S135 and the process of step of S150 of FIG. 4.

As shown in the above embodiment, the image processing system 1 continues to hold moving image data stored in the video signal storage unit 590 without deletion. By continuing to hold the moving image data transmitted from the moving image posting device 3 without deletion, even when the standard of the bitstream is changed in the future, it is possible to generate a bitstream of the changed standard on the basis of the moving image data transmitted from the moving image posting device 3. Accordingly, in the case in which the moving image data transmitted from the moving image posting device 3 has been deleted, when the standard is changed, a bitstream of the changed standard is generated from a bitstream of the standard prior to the change and therefore there is a possibility that a bitstream with deteriorated information will be generated. However, in the case in which moving image data is continuously held as shown in the above embodiment, such deterioration does not occur even when the standard has been changed.

In the example shown in the above embodiment, the decoding information storage unit 594 stores mode information and vector information as decoding information. However, the decoding information storage unit 594 may further store moving image identification information identifying a certain moving image or reference picture specification information specifying a reference picture, which is to be referred to, from among a group of pictures constituting a certain moving image. That is, the decoding information storage unit 594 may store, in association with each of a plurality of moving images to be stored, moving image identification information identifying each of the moving images, reference picture specification information which is information specifying each picture included in a group of pictures in the moving image and specifying a reference picture, mode information used for the reference, and vector information used for the reference.

In the case in which transcoding is performed using information stored in the decoding information storage unit 594, by referring to the decoding information storage unit 594, transcoding may be performed on the basis of moving image identification information and reference picture specification information of a moving image to be transcoded such that the moving image is transcoded using mode information and vector information in a macroblock corresponding to a combination of the moving image identification information and the reference picture specification information.

FIG. 2 conceptually shows an MPEG-based bitstream having a plurality of macroblocks, an example of which is described in detail using H.264 as follows. For example, in “macroblock layer syntax” specified in “Rec. ITU-T H264 (April 2013),” information items not stored in the decoding information storage unit 594 (that is, information items which the decoding unit 520 deletes without extracting them as decoding information from among those of bitstreams stored in the temporary storage unit 591) are “pcm_sample_luma,” “pcm_sample_chroma,” and “residual.” In other words, “pcm_sample_luma,” “pcm_sample_chroma,” and “residual” correspond to the COEF shown in FIG. 2. When generating a bitstream by referring to information (including mode information and vector information but not including the COEF) stored in the decoding information storage unit 594, the transcoding unit 503 acquires the COEF from a moving image read from the video signal storage unit 590 (for example, by performing motion compensation (MC), a discrete cosine transform (DCT), syntaxing, or the like) while reading and acquiring mode information and vector information from the decoding information storage unit 594. Since the MC+DCT based codec (MPEG-2, MPEG-4, or HEVC/265) or the like also has pixel difference information, the difference information may be deleted and other parts may be stored in the decoding information storage unit 594.

In addition, as described above that the moving image distribution device 5 is realized by one or more server computers or the like, the moving image distribution device 5 may be realized by one computer incorporating therein all functions shown in FIG. 3 (i.e., the moving image data reception unit 501, the distribution request reception unit 502, the transcoding unit 503, the bitstream transmission unit 504, the deletion unit 510, the decoding unit 520, the video signal storage unit 590, the temporary storage unit 591, the hit result information storage unit 592, the deletion condition information storage unit 593, and the decoding information storage unit 594) or alternatively may be realized by a plurality of computers into which all functions shown in FIG. 3 are incorporated in a distributed manner. That is, the moving image distribution device 5 may be realized by distributing some of the components of the moving image distribution device 5 over devices other than the moving image distribution device 5.

For example, the temporary storage unit 591, the decoding unit 520, and the decoding information storage unit 594 may be configured with a cache server as a separate device from the moving image distribution device 5 and may be connected to the moving image distribution device 5. Some of the other components of the moving image distribution device 5 may also be provided at the cache server.

A program for performing each process of the moving image distribution device 5 according to the embodiment of the present invention may be recorded on a computer readable recording medium and each process of the moving image distribution device 5 may be performed by allowing a computer system to read and execute the program recorded on the recording medium. The “computer system” referred to here may include an OS or hardware such as peripheral devices. In the case in which a WWW system is used, the “computer system” also includes a webpage providing environment (for example, a web server) or a webpage display environment (for example, a browser). The “computer readable recording medium” refers to a flexible disk, a magneto-optical disk, a ROM, a writable nonvolatile memory such as a flash memory, a portable medium such as a CD-ROM, or a storage device such as a hard disk installed in the computer system.

The “computer readable recording medium” also includes something that holds a program for a certain period of time, like a volatile memory (for example, a dynamic random access memory (DRAM)) in a computer system which serves as a server or a client when the program is transmitted via a network such as the Internet or via a communication line such as a telephone line.

The program may be transmitted from a computer system in which the program is stored in a storage device or the like to another computer system via a transmission medium or through transmission waves in a transmission medium. Here, the “transmission medium” for transmitting the program refers to a medium having a function of transmitting information such as a network (communication network) such as the Internet or a communication line (communication wires) such as a telephone line. The above program may be one for realizing some of the above-described functions. The program may also be a so-called differential file (differential program) which can realize the above-described functions in combination with a program already recorded in the computer system.

Although the embodiments of the present invention have been described above in detail with reference to the drawings, specific configurations thereof are not limited to those of these embodiments and include designs or the like within a range not deviating from the gist of the present invention.

### REFERENCE SYMBOLS

1 Image processing system

3 Moving image posting device

5 Moving image distribution device

7 Terminal device

9 Network

501 Moving image data reception unit

502 Distribution request reception unit

503 Transcoding unit

504 Bitstream transmission unit

510 Deletion unit

520 Decoding unit

590 Video signal storage unit

591 Temporary storage unit

592 Hit result information storage unit

593 Deletion condition information storage unit

594 Decoding information storage unit

1. An image processing system comprising:
a decoding unit configured to decode a bitstream, which is generated from moving image data stored in a video signal storage unit and is then stored in a temporary storage unit, before the bitstream is deleted;
a deletion unit configured to delete the bitstream from the temporary storage unit;
a decoding information storage unit configured to store decoding information obtained by performing the decoding; and
a transcoding unit configured to transcode the moving image data stored in the video signal storage unit using the decoding information.

2. The image processing system according to claim 1, wherein the decoding information includes at least one of vector information or mode information.

3. The image processing system according to claim 1, wherein the decoding unit is configured to perform decoding in response to input of an instruction to delete the bitstream from the temporary storage unit.

4. The image processing system according to claim 1, wherein the transcoding unit is configured to perform transcoding using the decoding information when the same or a different generation condition for generating the bitstream from the moving image data is given.

5. A transcoding method comprising:
decoding, by a decoding unit, a bitstream, which is generated from moving image data stored in a video signal storage unit and is then stored in a temporary storage unit, before the bitstream is deleted;
deleting, by a deletion unit, the bitstream from the temporary storage unit;
storing, by a decoding information storage unit, decoding information obtained by performing the decoding; and
transcoding, by a transcoding unit, the moving image data stored in the video signal storage unit using the decoding information.

6. A non-transitory computer-readable recording medium which stores a program that, when executed by a computer, causes the computer to perform:
a decoding step comprising decoding a bitstream to generate decoding information, which is generated from moving image data stored in a video signal storage unit and is then stored in a temporary storage unit, before the bitstream is deleted;
a deletion step comprising deleting the bitstream from the temporary storage unit;
a decoding information storage step comprising storing the decoding information obtained by the decoding step; and
a transcoding step comprising transcoding the moving image data stored in the video signal storage unit using the decoding information.
